(19) United States
(12) Patent Application Publication
(10) Pub. No.: US 2009/0269550 A1
(43) Pub. Date: Oct. 29, 2009

(54) Diffuser film and method of manufacturing the same

(76) Inventor: Yu-Chen Kuo Hsu, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/149,186

(22) Filed: Apr. 29, 2008

(51) Int. Cl. B32B 3/00; B29D 7/01

(52) U.S. Cl. 428/143; 428/141; 264/1.34

(57) ABSTRACT

A diffuser film and a method of manufacturing the same are proposes. A colloid layer is formed on a transparent substrate. A mold plate with a raised texture is then used to roll over the colloid layer to let the surface of the colloid layer have an indented texture. Finally, a solidification process is carried out to harden the colloid layer to form a coarse layer whose surface has an indented texture. The diffuser film can thus achieve the effects of light concentration and light uniformity promotion, and can also reduce astray light rays. Moreover, using a mold plate for embossing can accomplish high reproducibility of film thickness and indented texture of the coarse layer, hence being advantageous to mass production.

### BACKGROUND OF THE INVENTION

1. Field of the Invention

The present invention relates to a diffuser film and a method of manufacturing the same and, more particularly, to a diffuser film requiring no scattering particles and a method of manufacturing the same.

2. Description of Related Art

The function of a diffuser film is to diffuse passing light rays to achieve uniform distribution of light rays. An existent diffuser film is shown in FIG. 1. A resin layer added with scattering particles 12 is coated on a transparent substrate 10. A roller then rolls over the resin layer to form a specific raised texture. Next, the resin layer is then evaporated or hardened by baking to form a coarse layer 14. When light rays pass the diffuser film, they will be continually refracted, reflected, and scattered many times between scattering particles and resin with different refractive indices in the coarse layer 14, thereby accomplishing uniform distribution of light rays. During the compounding process of liquid resin material and solid scattering particles, however, it is very difficult to control the distribution density of solid material in liquid state. Moreover, factors such as material taking of the coating process and flow state and speed of liquid material will influence the distribution state of scattering particles. There are too many variables that can influence the properties of a diffuser film, which may result in unevenness of the total thickness and non-uniform distribution of scattering particles. Therefore, it is hard to control the uniformity promoting effect through refraction, reflection, and scattering of light rays in the coarse layer 14. This is a bottleneck in mass production and use of conventional diffuser films.

Furthermore, the coarse layer of all existent diffuser films has a raised texture. Although the surface coarseness of the diffuser film can be increased, the light concentration capability cannot be enhanced, resulting in a loss in light brightness.

Accordingly, the present invention aims to propose a diffuser film and a method of manufacturing the same to solve the above problems in the prior art.

### SUMMARY OF THE INVENTION

An object of the present invention is to provide a diffuser film and a method of manufacturing the same, in which a regular or irregular indented texture is formed on the surface of a coarse layer of the diffuser film to concentrate light and increase the surface coarseness.

Another object of the present invention is to provide a diffuser film requiring no scattering particles and a method of manufacturing the same.

Yet another object of the present invention is to provide a diffuser film and a method of manufacturing the same, in which a coarse layer with a regular or irregular indented/raised texture is formed by embossing with a mold plate to maintain reproducibility of coarseness of the indented/raised texture, thereby facilitating mass production.

Still yet another object of the present invention is to provide a diffuser film and a method of manufacturing the same, in which a regular/irregular indented texture and raised texture are respectively formed on the light entrance surface and the light exit surface of a coarse layer of the diffuser film to concentrate light and increase the surface coarseness.

To achieve the above objects, the present invention provides a diffuser film, which comprises a transparent substrate and a coarse layer located on the surface of the transparent substrate. The surface of the coarse layer has an indented texture.

The present invention also provides a method of manufacturing a diffuser film. The method comprises the steps of: providing a transparent substrate; forming a colloid layer on the transparent substrate; using a mold plate whose surface has a raised/indented texture to roll over the colloid layer to form an indented/raised texture on the surface of the colloid layer; and solidifying the colloid layer to form a coarse layer whose surface has an indented/raised texture.

The present invention also provides a diffuser film, which comprises a transparent substrate, a coarse layer with an indented texture located on an upper surface of the transparent substrate, and a coarse layer with a raised texture located on a lower surface of the transparent substrate.

The present invention also provides a method of manufacturing the above diffuser film. The method comprises the steps of: providing a transparent substrate; forming a first colloid layer and a second colloid layer on the transparent substrate; using a mold plate whose surface has a raised texture and a mold plate whose surface has an indented texture to roll over the first colloid layer and the second colloid layer to form an indented texture on the surface of the first colloid layer and a raised texture on the surface of the second colloid layer, respectively; and solidifying the first colloid layer and the second colloid layer to form a coarse layer with an indented texture and a coarse layer with a raised texture, respectively.

### BRIEF DESCRIPTION OF THE DRAWINGS

The various objects and advantages of the present invention will be more readily understood from the following detailed description when read in conjunction with the appended drawing, in which:

FIG. 1 is a structure diagram of a diffuser film in the prior art;

FIG. 2 is a structure diagram of the diffuser film according to a first embodiment of the present invention;

FIG. 3 is flowchart of the method of manufacturing the diffuser film according to the first embodiment of the present invention;

FIG. 4 is flowchart of the method of manufacturing the diffuser film according to a second embodiment of the present invention;

FIG. 5 is a structure diagram of the diffuser film manufactured by the steps of FIG. 4;

FIG. 6 is a structure diagram of the diffuser film according to a third embodiment of the present invention; and

FIG. 7 is a flowchart of the method of manufacturing the diffuser film according to the third embodiment of the present invention.

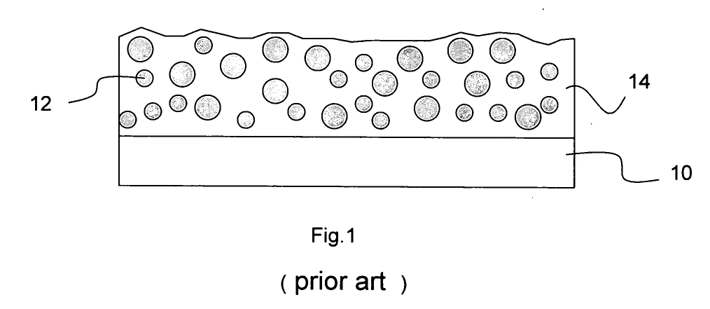

### DETAILED DESCRIPTION OF THE PREFERRED EMBODIMENTS

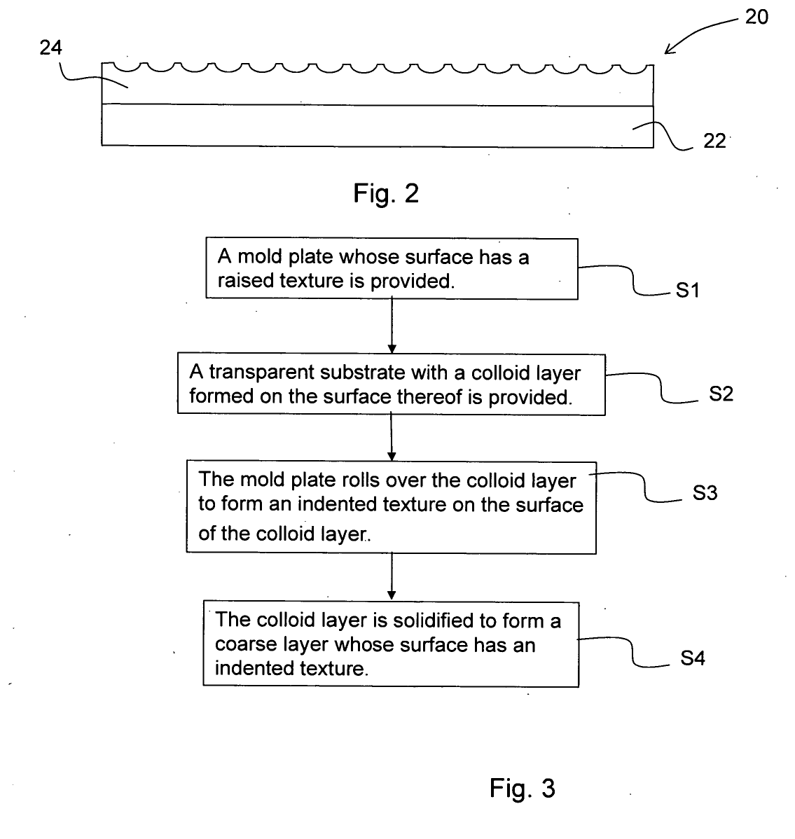

FIG. 2 is a structure diagram of the diffuser film according to a first embodiment of the present invention. As shown in FIG. 2, a diffuser film 20 of the present invention comprises a transparent substrate 22 and a coarse layer 24 located on the transparent substrate 22. The transparent substrate 22 is made of Polyethylene Terephthalate (PET). The surface of the coarse layer 24 has a regular or irregular indented texture to increase the surface coarseness, enhance antireflection, improve light concentration, reduce astray light, and promote light uniformity.

FIG. 3 is flowchart of the method of manufacturing the diffuser film according to the first embodiment of the present invention. First, a mold plate whose surface has a raised texture is provided (Step S1). The raised texture can be formed by stacking particles. Next, a transparent substrate with a colloid layer formed on the surface thereof is provided (Step S2). The colloid layer is made of thermosetting resin. The mold plate whose surface has a raised texture rolls over the colloid layer to form an indented texture on the surface of the colloid layer (Step S3). Finally, the colloid layer is solidified to form a coarse layer whose surface has an indented texture (Step S4).

The size of the raised texture on the mold plate is of micrometer or nanometer scale.

Using the manufacturing method of the present invention, the raised texture on the mold plate and the embossing pressure can be controlled to achieve film thickness control of the coarse layer and reproducibility of the embossed indented texture, thereby making the quality and characteristics of the diffuser film are uniform to facilitate mass production.

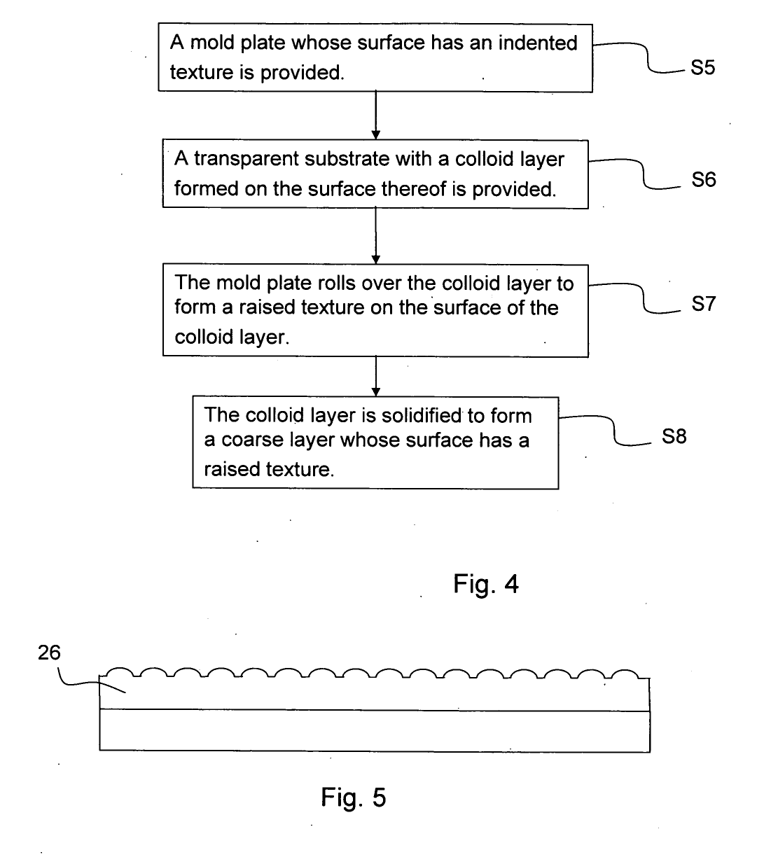

The above diffuser film whose surface has an indented texture can be used as a light entrance surface by using its light concentration function. The present invention also provides a method of manufacturing a diffuser film whose surface has a raised texture. FIG. 4 is flowchart of the method of manufacturing the diffuser film according to a second embodiment of the present invention. First, a mold plate whose surface has an indented texture is provided (Step S5). Next, a transparent substrate with a colloid layer formed on the surface thereof is provided (Step S6). The colloid layer is made of thermosetting resin. The mold plate whose surface has an indented texture rolls over the colloid layer to form a raised texture on the surface of the colloid layer (Step S7). Finally, the colloid layer is solidified to form a coarse layer 26 shown in FIG. 5 whose surface has a raised texture (Step S8). The surface with this raised texture can be used as a light exit surface of the diffuser film.

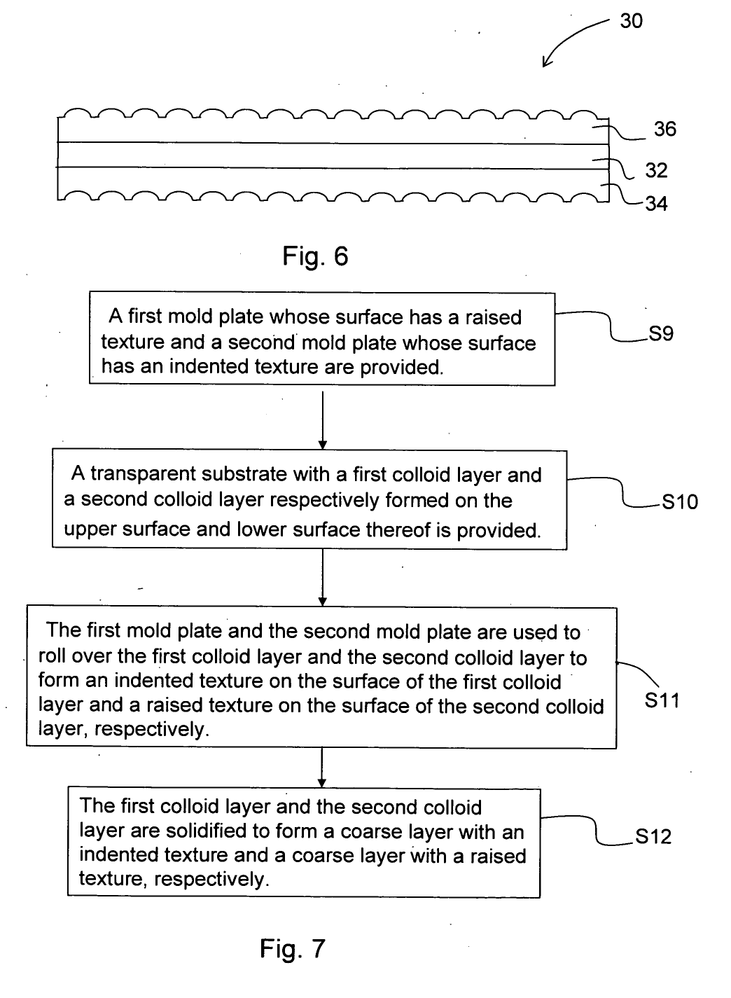

FIG. 6 is a structure diagram of the diffuser film according to a third embodiment of the present invention. As shown in FIG. 6, a diffuser film 30 of the present invention comprises a transparent substrate 32, a first coarse layer 34 located on a light entrance surface of the transparent substrate 32, and a second coarse layer 36 located on a light exit surface of the transparent substrate 32. The transparent substrate 32 is made of PET. The surface of the first coarse layer 34 has a regular or irregular indented texture to increase coarseness, improve antireflection, and enhance light concentration. The surface of the second coarse layer 36 has a regular or irregular raised texture to increase coarseness and promote light uniformity.

FIG. 7 is a flowchart of the method of manufacturing the diffuser film according to the third embodiment of the present invention. First, a first mold plate and a second mold plate are provided (Step S9). The surface of the first mold plate has a raised texture formed by stacking particles. The surface of the second mold plate has an indented texture. A first colloid layer and a second colloid layer are then formed on the upper surface and lower surface of a transparent substrate, respectively (Step S10). The colloid layer is made of thermosetting resin. Next, the first mold plate and the second mold plate are used to roll over the first colloid layer and the second colloid layer to form a regular or irregular indented texture on the surface of the first colloid layer and a regular or irregular raised texture on the second colloid layer, respectively (Step S11). Finally, the first and second colloid layers are solidified to form a coarse layer with an indented texture and a coarse layer with a raised texture.

To sum up, the present invention discloses a diffuser film requiring no scattering particles and a method of manufacturing the same. A mold plate whose surface has a raised texture is used to roll over a colloid layer on a transparent substrate to form a diffuser film whose surface has a coarse layer with an indented texture, thereby enhancing light concentration and increasing the surface coarseness of the diffuser film. No scattering particles are required for increasing the surface coarseness and promoting light uniformity. Moreover, the present invention also discloses another diffuser film and a method of manufacturing the same. A mold plate whose surface has a raised texture and a mold plate whose surface has an indented texture are used to roll over a first colloid layer and a second colloid layer on the upper surface and the lower surface of a transparent substrate to form a coarse layer with an indented texture and a coarse layer with a raised texture on the upper surface and lower surface of the transparent substrate, respectively, thereby enhancing light concentration and increasing the surface coarseness of the diffuser film. The present invention further discloses another diffuser film requiring no scattering particles and a method of manufacturing the same. A mold plate whose surface has an indented texture is used to roll over a colloid layer on a transparent substrate to form a diffuser film whose surface has a coarse layer with a raised texture, thereby increasing the surface coarseness of the diffuser film. The coarse layer with a raised texture can be used as a light exit surface of the diffuser film.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A diffuser film comprising:
a transparent substrate; and
a coarse layer located on a surface of said transparent substrate, the surface of said coarse layer having an indented texture.

2. The diffuser film as claimed in claim 1, wherein said transparent substrate is made of PET.

3. The diffuser film as claimed in claim 1, wherein said coarse layer with an indented texture is made of thermosetting resin.

4. The diffuser film as claimed in claim 1, wherein said coarse layer with an indented texture is formed by embossing with a mold plate whose surface has a raised texture.

5. The diffuser film as claimed in claim 4, wherein the raised texture on said mold plate is formed by stacking particles.

6. The diffuser film as claimed in claim 4, wherein the size of the raised texture on said mold plate is of micrometer or nanometer scale.

7. The diffuser film as claimed in claim 1, wherein another coarse layer whose surface has a raised texture is provided on the other surface of said transparent substrate.

8. A method of manufacturing a diffuser film comprising the steps of:
providing a transparent substrate;
forming a colloid layer on said transparent substrate;
using a mold plate whose surface has a raised texture to roll over said colloid layer to form an indented texture on the surface of said colloid layer; and
solidifying said colloid layer to form a coarse layer.

9. The method of manufacturing a diffuser film as claimed in claim 8, wherein said transparent substrate is made of PET.

10. The method of manufacturing a diffuser film as claimed in claim 8, wherein said colloid layer is made of thermosetting resin.

11. The method of manufacturing a diffuser film as claimed in claim 8, wherein the raised texture on said mold plate is formed by stacking particles.

12. The method of manufacturing a diffuser film as claimed in claim 8, wherein the size of the raised texture on said mold plate is of micrometer or nanometer scale.

13. A diffuser film comprising:
a transparent substrate;
a coarse layer with an indented texture located on an upper surface of said transparent substrate; and
a coarse layer with a raised texture located on a lower surface of said transparent substrate.

14. The diffuser film as claimed in claim 13, wherein said coarse layer with an indented texture is formed by embossing with a mold plate whose surface has a raised texture.

15. The diffuser film as claimed in claim 13, wherein said coarse layer with a raised texture is formed by embossing with a mold plate whose surface has an indented texture.

16. The diffuser film as claimed in claim 14, wherein the raised texture on said mold plate is formed by stacking particles.

17. The diffuser film as claimed in claim 13, wherein said transparent substrate is made of PET.

18. The diffuser film as claimed in claim 13, wherein said coarse layer with an indented texture is made of thermosetting resin.

19. The diffuser film as claimed in claim 15, wherein the size of the indented texture on said mold plate is of micrometer or nanometer scale.

20. The diffuser film as claimed in claim 16, wherein the size of the raised texture on said mold plate is of micrometer or nanometer scale.

21. The diffuser film as claimed in claim 13, wherein said coarse layer with an indented texture is a light entrance surface of said diffuser film, and said coarse layer with a raised texture is a light exit surface of said diffuser film.

22. A method of manufacturing a diffuser film comprising the steps of:
providing a transparent substrate;
forming a first colloid layer and a second colloid layer on said transparent substrate;
using a mold plate whose surface has a raised texture and a mold plate whose surface has an indented texture to roll over said first colloid layer and said second colloid layer to form an indented texture on the surface of said first colloid layer and a raised texture on the surface of said second colloid layer, respectively; and
solidifying said first colloid layer and said second colloid layer to form a coarse layer with an indented texture and a coarse layer with a raised texture, respectively.

23. The method of manufacturing a diffuser film as claimed in claim 22, wherein said transparent substrate is made of PET.

24. The method of manufacturing a diffuser film as claimed in claim 8, wherein both said first colloid layer and said second colloid layer are made of thermosetting resin.

25. The method of manufacturing a diffuser film as claimed in claim 22, wherein the raised texture on said mold plate is formed by stacking particles.

26. The method of manufacturing a diffuser film as claimed in claim 22, wherein the size of the raised/indented texture on said mold plates is of micrometer or nanometer scale.

27. A method of manufacturing a diffuser film comprising the steps of:
providing a transparent substrate;
forming a colloid layer on said transparent substrate;
using a mold plate whose surface has an indented texture to roll over said colloid layer to form a raised texture on the surface of said colloid layer; and
solidifying said colloid layer to form a coarse layer with a raised texture.

28. The method of manufacturing a diffuser film as claimed in claim 27, wherein said transparent substrate is made of PET.

29. The method of manufacturing a diffuser film as claimed in claim 27, wherein said colloid layer is made of thermosetting resin.
